(19) United States
(12) Patent Application Publication
(10) Pub. No.: US 2026/0312912 A1
(43) Pub. Date: Oct. 8, 2026

(54) ONE-TO-MANY LOW-LATENCY WIRELESS COMMUNICATION METHOD AND DEVICE

(71) Applicant: NANJING QINHENG MICROELECTRONICS CO., LTD., Nanjing (CN)

(72) Inventors: Fangliang ZHANG, Nanjing (CN); Yong YANG, Nanjing (CN)

(73) Assignee: NANJING QINHENG MICROELECTRONICS CO., LTD., Nanjing (CN)

(21) Appl. No.: 19/321,098

(22) Filed: Sep. 5, 2025

(30) Foreign Application Priority Data
Apr. 7, 2025 (CN) 2025104265349

(51) Int. Cl. H04L 47/32

(52) U.S. Cl. CPC H04L 47/32

(57) ABSTRACT

The invention discloses a one-to-many low-latency wireless communication method and device. The method comprises the following steps of: allowing at least a first communication terminal, a second communication terminal and a third communication terminal to agree on a transmission rule of a data packet, and in a transmission process of the data packet, monitoring, by a next communication terminal to send a data packet, the data packet and starting to send a next data packet immediately after the data packet is sent, receiving, by the first communication terminal, all data packets, and recombining and restoring the data packets sent by various communication terminals according to the transmission rule.

### CROSS-REFERENCE TO RELATED APPLICATIONS

This application claims priority to Chinese Patent Application Ser. No. CN2025104265349 filed on 7 Apr. 2025.

### TECHNICAL FIELD

The present invention belongs to the technical field of wireless communication, and particularly relates to a one-to-many low-latency wireless communication method and device.

### BACKGROUND

Traditional wireless keyboard and mouse are generally implemented by two solutions. (1) The keyboard and the mouse are respectively matched with a dongle, wherein one dongle is used with the keyboard and the other dongle is used with the mouse, a transmission delay is low theoretically, but two dongles need to be used, and there is interference between the dongles when being used at the same time, which is easy to cause wireless data packet dropout. (2) The keyboard and the mouse share one dongle, the dongle communicates with the keyboard for receiving and sending data in a certain period of time, and communicates with the mouse for receiving and sending data in another period of time, and an identify label must be added into a transmitted data packet to distinguish a current communicator. However, this method may cause a large communication delay for each device, because when the dongle communicates with one of the devices, if another device needs to transmit data, data transmission can only be carried out when the dongle sends a communication request to another device after the communication between the dongle and the communication device is ended. However, this method may have a longer delay in a wireless communication application scenario of improving a one-way transmission rate. For example, according to the solution of the prior art CN117768952B, a return rate of 8 k can be achieved in a one-to-one wireless communication scenario, but only a return rate of 500 Hz can be achieved in a one-to-many wireless communication scenario, so that the experience of high-rate wireless keyboard and mouse is poor.

Therefore, in one-to-many wireless communication application scenarios similar to situations such as dongle sharing between the keyboard and the mouse in the above traditional solution (2), there is a one-way high-rate and low-latency demand.

### SUMMARY

Objective of the invention: in order to solve the problem of large delay in a traditional one-to-many wireless communication method in the prior art, the present invention provides a one-to-many low-latency wireless communication method and device.

Technical solution: a one-to-many low-latency wireless communication method comprises the following steps of:
allowing at least a first communication terminal, a second communication terminal and a third communication terminal to agree on a transmission rule of a data packet, wherein the transmission rule contains a sending sequence of at least the second communication terminal and the third communication terminal in a transmission period; and
allowing one transmission period to contain a sending part of the first communication terminal and a receiving part of the first communication terminal, wherein:
for the sending part of the first communication terminal, the first communication terminal sends a first data packet, and the second communication terminal and the third communication terminal receive the first data packet, wherein the first data packet contains a response of the data packet received by the first communication terminal; and
for the receiving part of the first communication terminal, the second communication terminal and the third communication terminal send the data packet in sequence according to the transmission rule, wherein, when a data packet si is transmitted, i represents a serial number of the data packet and i is an integer ≥0, a next communication terminal to send a data packet in the transmission rule monitors the data packet si and starts to send a data packet s(i+1) immediately after the data packet si is sent, the first communication terminal receives all data packets, and recombines and restores the data packets sent by various communication terminals according to the transmission rule until the second communication terminal and the third communication terminal send the data packets required to be sent in the transmission period according to the transmission rule.

Further, in one transmission period, the second communication terminal and the third communication terminal send the data packet in sequence for multiple times.

Further, for the receiving part of the first communication terminal, when the transmission rule stipulates that a certain communication terminal sends a data packet at a certain moment, and the communication terminal has no data packet to be sent, a null packet is sent, the next communication terminal to send the data packet in the transmission rule detects the null packet, and after the null packet is sent, a next data packet to be sent is sent immediately.

Further, for the receiving part of the first communication terminal, when the transmission rule stipulates that a certain communication terminal sends a data packet at a certain moment, and the communication terminal has no data packet to be sent, no packet is sent; and at this time, in a case that the next communication terminal to send the data packet monitors no data packet, a timekeeping and waiting operation starts to be carried out until a transmission duration of one data packet is ended, and the next communication terminal to send the data packet starts to send a next data packet.

Further, in one transmission period, a sending operation is carried out before a receiving operation of the first communication terminal, and the first data packet contains the response of the data packet received by the first communication terminal in a previous transmission period.

Further, the response comprises a response of the data packet sent by the second communication terminal and a response of the data packet sent by the third communication terminal.

Further, a monitoring method comprises: acquiring a transmission duration parameter of the data packet si, dynamically calculating a remaining transmission time Δt through a physical layer packet length detection algorithm, estimating a transmission end time of the data packet si, and preparing for transmitting the data packet s (i+1) at the same time.

Further, a duration of the transmission period is not fixed, and after the second communication terminal and the third communication terminal transmit all data packets in the transmission period according to the transmission rule, the receiving part of the first communication terminal in the transmission period is ended, and the sending part of the first communication terminal in the transmission period or a next transmission period is started.

A one-to-many low-latency wireless communication device adopting the one-to-many low-latency wireless communication method above comprises at least the first communication terminal, the second communication terminal and the third communication terminal.

Further, the first communication terminal is a wireless dongle, and the second communication terminal and the third communication terminal are wireless input apparatuses.

Compared with the prior art, the one-to-many low-latency wireless communication method and device provided by the present invention have the following beneficial effects:
a channel resource utilization rate is effectively improved through a dynamic time sequence coordination mechanism and a zero-latency sending method of transmission state perception between the communication terminals, and a more obvious effect on reducing a transmission delay in a certain direction is achieved, so as to improve a one-way transmission rate of multiple communication terminals, and taking the wireless keyboard and mouse as an example, the wireless keyboard and mouse can both achieve a return rate of 8 k;
in a transmission process of the data packet, there is no need to contain an identity label of each device, so that more effective data can be transmitted, and transmission resources are saved; and
a traditional thinking pattern of fixed communication period is broken, the transmission is more flexible, the communication delay is further reduced, and the present invention is especially suitable for occasions with higher requirements on transmission efficiency and real-time performance.

### BRIEF DESCRIPTION OF THE DRAWINGS

FIG. 1 shows a transmission situation of one transmission period in a one-to-many delay wireless communication method of the embodiment; and

FIG. 2 shows a transmission situation when a certain communication terminal monitors no data packet in one transmission period.

### DETAILED DESCRIPTION

The present invention is further explained and described hereinafter with reference to the drawings and specific embodiments.

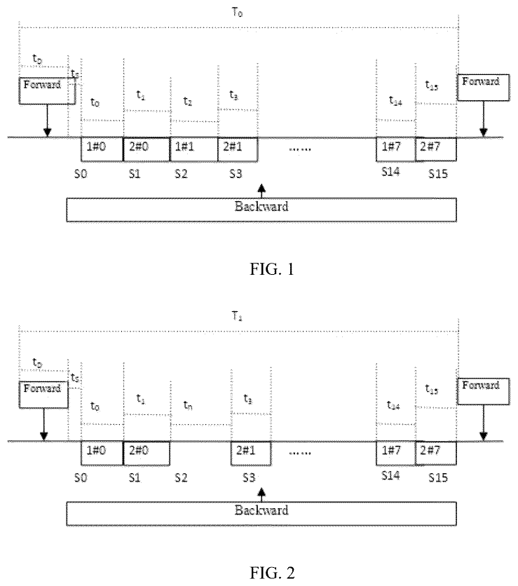

A one-to-many low-latency wireless communication method, as shown in FIG. 1, comprises the following steps.

At least a first communication terminal, a second communication terminal and a third communication terminal agree on a transmission rule of a data packet, wherein the transmission rule contains a sending sequence of at least the second communication terminal and the third communication terminal in a transmission period.

One transmission period contains a sending part of the first communication terminal and a receiving part of the first communication terminal (abbreviated as forward and backward parts in FIG. 1 and FIG. 2). A sequence of the two parts in the same transmission period is not limited, that is, the first communication terminal may send the data packet first, or receive the data packet first. In the embodiment, a sending operation is carried out before a receiving operation of the first communication terminal, and a first data packet contains a response of the data packet received by the first communication terminal in a previous transmission period. According to such arrangement, the first data packet sent by the first communication terminal may contain a time stamp, and the first communication terminal may perform synchronous calibration according to the time stamp, so that the requirement of the device on clock precision is reduced, and the method may be applied to frequency hopping and low power consumption applications, so as to improve an anti-interference ability of wireless transmission and save power consumption. The first data packet may also contain an agreed sending sequence, which is convenient for the second communication terminal and the third communication terminal to transmit the first data packet according to the sequence after receiving the first data packet.

For the sending part of the first communication terminal, the first communication terminal sends the first data packet, and the second communication terminal and the third communication terminal receive the first data packet, wherein the first data packet contains the response of the data packet received by the first communication terminal. The response comprises a response of the data packet sent by the second communication terminal and a response of the data packet sent by the third communication terminal, which is convenient for the second communication terminal and the third communication terminal to confirm a receiving situation of the first communication terminal, so as to choose whether to continuously send or resend the data packet (in a case of packet dropout).

For the receiving part of the first communication terminal, the second communication terminal and the third communication terminal send the data packet in sequence according to the transmission rule. As shown in FIG. 1, s0, s1, s2 . . . s15 respectively represent data packets with serial numbers of 0, 1, 2 . . . 15. When a data packet si is transmitted, i represents a serial number of the data packet and i is an integer ≥0, a next communication terminal to send a data packet in the transmission rule monitors the data packet si and starts to send a data packet s(i+1) immediately after the data packet si is sent, and the first communication terminal receives all data packets, and recombines and restores the data packets sent by various communication terminal according to the transmission rule. All data packets should contain packet serial numbers, and the packet serial numbers of the data packets sent by different communication terminals are relatively independent, so that data sent by various communication terminals may be restored respectively according to the received packet serial numbers, until the second communication terminal and the third communication terminal send the data packets required to be sent in the transmission period according to the transmission rule.

An end signal of the data packet may be directly detected by monitoring. A next data packet is sent immediately when the end signal is detected, or an end time may be estimated by detecting a start signal of the data packet to prepare for sending the next data packet in advance, and the next data packet is sent immediately after a previous data packet is sent, so that the next data packet may be prepared in advance. On the other hand, the monitoring action may be ended in advance to save power consumption. The later monitoring method specifically comprises: acquiring a transmission duration parameter of the data packet si, dynamically calculating a remaining transmission time Δt through a physical layer packet length detection algorithm, estimating a transmission end time of the data packet si, and preparing for transmitting the data packet s(i+1) at the same time.

In one transmission period, numbers of sending times and a sending sequence of the second communication terminal and the third communication terminal may be set at will, and a duration of each data packet may also be set at will, as long as the three parties make an agreement. For example, in order to improve a one-way transmission rate and reduce a delay, for the receiving part of the first communication terminal in one transmission period, the second communication terminal and the third communication terminal both send the data packet at least twice respectively in sequence. For example, the sending sequence is as follows: the second communication terminal sends the data packet, the third communication terminal sends the data packet, the second communication terminal sends the data packet, and the third communication terminal sends the data packet. Certainly, a sending proportion of each communication terminal excluding the first communication terminal may be set reasonably as required. For example, if three communication terminals transmit data with the first communication terminal, the receiving part of the first communication terminal in one transmission period comprises that: the second communication terminal sends the data packet and the third communication terminal sends the data packet, the second communication terminal sends the data packet and the fourth communication terminal sends the data packet, and so on.

Although the transmission rule stipulates the sending sequence of the communication terminals excluding the first communication terminal, it is not indicated that a certain communication terminal must have data to be sent at a certain moment, that is, the communication terminal has no data to be sent at a stipulated sending moment. In this case, the communication terminal may send a null packet or may send no packet. If the null packet is sent, the next communication terminal to send the data packet in the transmission rule detects the null packet, and after the null packet is sent, a next data packet to be sent is sent immediately. If no packet is sent, the next communication terminal to send the data packet in the transmission rule monitors no data packet at this time, then a timekeeping and waiting operation starts to be carried out until a transmission duration of one data packet is ended, and the next communication terminal to send the data packet starts to send the next data packet. As shown in FIG. 2, it is indicated that a data packet s2 is not sent, and the next data packet starts to be sent when a reserved tn time is reached. In conclusion, when the next communication terminal to send the data packet in the transmission rule monitors the previous data packet, if the data packet (containing the null packet) is detected, the next data packet is sent immediately after the data packet is transmitted, and if no data packet is detected, a time of the data packet is reserved, and the next data packet starts to be sent after the time is over.

After the data packet is sent, the next data packet may start to send the next data packet immediately, and the data packet may not be full, which may lead to an unfixed duration of the transmission period. As shown in FIG. 1 and FIG. 2, T₀ and T₁ are not necessarily equal. After the second communication terminal and the third communication terminal transmit all data packets in the transmission period according to the transmission rule, the receiving part of the first communication terminal in the transmission period is ended, and the sending part of the first communication terminal in the transmission period or a next transmission period is started.

A one-to-many low-latency wireless communication device adopting the one-to-many low-latency wireless communication method above comprises at least the first communication terminal, the second communication terminal and the third communication terminal. The first communication terminal is a wireless dongle, and the second communication terminal and the third communication terminal are wireless input apparatuses. For example, the second communication terminal is a wireless mouse, and the third communication terminal is a wireless keyboard.

An application of wireless keyboard and mouse is taken as an example hereinafter. Common 2.4 G data frames are as follows:

### (1) A Dongle Sends a Response Frame

| | Synchronization | | |
|---|---|---|---|
| Frame header | word | Protocol header | CRC check |
| 16 bit | 24 bit-40 bit | 8 bit-16 bit | 8 bit-24 bit |

Total data frame bit number: 16+24+8+8=56 or 16+40+16+24=96.

Taking a data rate of 2 M as an example, that is, 0.5 us/bit, a time for the dongle to send the data frame is 28 us to 48 us.

Taking a data rate of 4 M as an example, that is, 0.25 us/bit, a time for the dongle to send the data frame is 14 us to 24 us.

In FIG. 1, t_{D} represents a sending time of a forward data frame, which contains an RF startup duration of about 40 us and a duration of the above data frame, that is, t_{D}=RF startup duration of 40 us+duration of data frame, and tₛ is a receiving and sending switching time of about 20 us.

### (2) a Mouse Terminal Sends a Valid Data Frame

| Frame header | Synchronization word | Protocol header | Valid data | CRC check |
|---|---|---|---|---|
| 16 bit | 24 bit-40 bit | 8 bit-16 bit | 6*8 bit | 8 bit-24 bit |

Total data frame bit number: 16+24+8+48+8=104 or 16+40+16+48+24=144

Taking a data rate of 2 M as an example, that is, 0.5 us/bit, a time for the mouse to send the data frame is 52 us to 72 us.

Taking a data rate of 4 M as an example, that is, 0.25 us/bit, a time for the mouse to send the data frame is 26 us to 36 us.

In FIG. 1, t₀, t₂ . . . t₁₄ are respectively the time for the mouse to send the data frame.

### (3) a Keyboard Terminal Sends a Valid Data Frame

| Frame | Synchronization | Protocol | | |
|---|---|---|---|---|
| header | word | header | Valid data | CRC check |
| 16 bit | 24 bit-40 bit | 8 bit-16 bit | 8*8 bit -16*8 | 8 bit-24 bit |
| | | | bit | |

Total data frame bit number: 16+24+8+64+8=120 or 16+40+16+128+24=208

Taking a data rate of 2 M as an example, that is, 0.5 us/bit, a time for the keyboard to send the data frame is 60 us to 104 us.

Taking a data rate of 4 M as an example, that is, 0.25 us/bit, a time for the keyboard to send the data frame is 30 us to 52 us.

In FIG. 1, t₁, t₃ . . . t₁₅ are respectively the time for the keyboard to send the data frame.

In one period, the keyboard and the mouse respectively send 8 data frames until the data frames are received, and a time of one period is T=t_{D}+t_{S}+(t₀+t₁+ . . . t₁₅).

The keyboard and the mouse send data alternately, a delay time of each packet of the keyboard is a time for the mouse to send data, a delay time of each packet of the mouse is a time for the keyboard to send data, and a delay time of a first packet of the mouse is a time for the dongle to send the data packet.

Taking a rate of 4 M as an example, according to a longest data frame, T=40 us+24 us+20 us+36 us*8+52 us*8=788 us.

In an actual use process, the data may also be compressed, and in remaining time,a controller has enough time for processing. Within 1 ms, two devices transmit 8 data frames respectively, so that the two device may both achieve a return rate of 8 k.

What is claimed is:

1. A one-to-many low-latency wireless communication method, comprising the following steps of:
allowing at least a first communication terminal, a second communication terminal and a third communication terminal to agree on a transmission rule of a data packet, wherein the transmission rule contains a sending sequence of at least the second communication terminal and the third communication terminal in a transmission period; and
allowing one transmission period to contain a sending part of the first communication terminal and a receiving part of the first communication terminal, wherein:
for the sending part of the first communication terminal, the first communication terminal sends a first data packet, and the second communication terminal and the third communication terminal receive the first data packet, wherein the first data packet contains a response of the data packet received by the first communication terminal; and
for the receiving part of the first communication terminal, the second communication terminal and the third communication terminalsendthe data packet in sequence according to the transmission rule, wherein, when a data packet si is transmitted, i represents a serial number of the data packet and i is an integer ≥0, a next communication terminal to send a data packet in the transmission rulemonitorsthe data packet si and starts to send a data packet s(i+1) immediately after the data packet si is sent, the first communication terminalreceivesall data packets, and recombines and restores the data packets sent by various communication terminals according to the transmission rule until the second communication terminal and the third communication terminal send the data packets required to be sent in the transmission period according to the transmission rule;
a duration of the transmission period is not fixed, and after the second communication terminal and the third communication terminal transmit all data packets in the transmission period according to the transmission rule, the receiving part of the first communication terminal in the transmission period is ended.

2. The one-to-many low-latency wireless communication method according to claim 1, wherein, in one transmission period, the second communication terminal and the third communication terminal send the data packet in sequence for multiple times.

3. The one-to-many low-latency wireless communication method according to claim 1, wherein, for the receiving part of the first communication terminal, when the transmission rule stipulates that a certain communication terminal sends a data packet at a certain moment, and the communication terminal has no data packet to be sent, a null packet is sent, the next communication terminal to send the data packet in the transmission rule detects the null packet, and after the null packet is sent, a next data packet to be sent is sent immediately.

4. The one-to-many low-latency wireless communication method according to claim 1, wherein, for the receiving part of the first communication terminal, when the transmission rule stipulates that a certain communication terminal sends a data packet at a certain moment, and the communication terminal has no data packet to be sent, no packet is sent; and at this time, in a case that the next communication terminal to send the data packet monitors no data packet, a timekeeping and waiting operation starts to be carried out until a transmission duration of one data packet is ended, and the next communication terminal to send the data packet starts to send a next data packet.

5. The one-to-many low-latency wireless communication method according to claim 1, wherein, in one transmission period, a sending operation is carried out before a receiving operation of the first communication terminal, and the first data packet contains the response of the data packet received by the first communication terminal in a previous transmission period.

6. The one-to-many low-latency wireless communication method according to claim 5, wherein the response comprises a response of the data packet sent by the second communication terminal and a response of the data packet sent by the third communication terminal.

7. The one-to-many low-latency wireless communication method according to claim 1, wherein a monitoring method comprises: acquiring a transmission duration parameter of the data packet si, dynamically calculating a remaining transmission time Δt through a physical layer packet length detection algorithm, estimating a transmission end time of the data packet si, and preparing for transmitting the data packet s(i+1) at the same time.

8. The one-to-many low-latency wireless communication method according to claim 1, wherein the receiving part of the first communication terminal in the transmission period is ended, and the sending part of the first communication terminal in the transmission period or a next transmission period is started.

9. A one-to-many low-latency wireless communication device adopting the one-to-many low-latency wireless communication method according to claim 1, comprising at least the first communication terminal, the second communication terminal and the third communication terminal.

10. The one-to-many low-latency wireless communication device according to claim 9, wherein the first communication terminal is a wireless dongle, and the second communication terminal and the third communication terminal are wireless input apparatuses.
